(19) United States
(12) Patent Application Publication
(10) Pub. No.: US 2022/0317672 A1
(43) Pub. Date: Oct. 6, 2022

(54) A Visualization Method for Process Monitoring Based on Bi-kernel T-distributed Stochastic Neighbor Embedding

(71) Applicant: BEIJING UNIVERSITY OF TECHNOLOGY, BEIJING (CN)

(72) Inventors: Pu Wang, BEIJING (CN); Haili Zhang, BEIJING (CN); Xuejin Gao, BEIJING (CN); Huihui Gao, BEIJING (CN); Huayun Han, BEIJING (CN)

(21) Appl. No.: 17/843,683

(22) Filed: Jun. 17, 2022

Related U.S. Application Data
(63) Continuation of application No. PCT/CN2020/101990, filed on Jul. 15, 2020.

(30) Foreign Application Priority Data
Jun. 16, 2020 (CN) 202010550245.7

(51) Int. Cl. G05B 23/02

(52) U.S. Cl. CPC G05B 23/0272

(57) ABSTRACT

The invention discloses a visualization method for process monitoring based on bi-kernel t-distributed stochastic neighbor embedding. It includes two steps of offline modeling and online monitoring. In offline modeling, standard t-SNE method is used to reduce the dimension of historical normal data. The mapping parameter matrix from the input kernel matrix to the feature kernel matrix is calculated. PCA is used to reduce the feature kernel matrix to two dimensions, and then the square Mahalanobis distance is calculated as a statistic and the control limit is solved. Online monitor and calculate the kernel function to between the collected data and the modeling data; and the obtained kernel vector is multiplied by the mapping parameter matrix to obtain the mapped feature kernel vector. PCA is used to reduce the dimension of the mapped feature kernel vector to obtain two-dimensional features for visualization. Draw the scatter diagram of the feature and observe whether it is within the ellipse control limit. Compared with the prior art, the present invention retains the advantage of data dimension reduction of the standard t-SNE method, and meanwhile applies it to the visualization of industrial process fault monitoring, reducing the rate of misreport and underreport of industrial process monitoring.

### CROSS-REFERENCE TO RELATED APPLICATION

This application is a continuation of International Application PCT/CN2020/101990 filed on Jul. 15, 2020, which claims the priority benefits to Chinese Patent Application No. 202010550245.7 filed on Jun. 16, 2020, the content of the above identified applications is hereby incorporated by reference in its entirety.

### FIELD OF THE INVENTION

The present invention belongs to the technical field of fault monitoring, which relates to industrial process fault monitoring visualization technology based on data-driven, particularly, an online monitoring visualization method for the industrial process of bi-kernel t-distributed stochastic neighbor embedding (bi-kernel t-SNE).

### BACKGROUND TECHNOLOGY

Fault monitoring is an important means to ensure the production safety and product quality of industrial process. The distributed control system collects measurements from hundreds of sensors and transmits them to the host computer, visualizing these measurements in the user interface, showing variation trends, outliers, and clustering of the data to monitor the state of plant operations and help engineers to make decisions.

The fault monitoring visualization technologies can be roughly divided into two categories: univariate and multivariate methods. A univariate control chart means that only one variable is drawn in one chart. Shewhart graph, cumulative summation method and exponential weighted moving average method are three kinds of univariate fault monitoring visualization technologies widely used in enterprises. When the variable change is beyond a certain threshold range, it is identified as a fault and an alarm is triggered. But the univariate method, which assumes that the variables are independent and normally distributed, can cause a large number of false alarms in a multivariate process. Multivariate process monitoring methods, such as Principal Component Analysis (PCA), extract features from high-dimensional data to construct a small number of fault monitoring indexes, which are plotted in line graphs for visualization. In this way, the correlation between the variables is extracted and the multivariate problem is transformed into a univariate problem. T² and SPE statistics represent square Mahaobanobis distance and square Euclidean distance respectively, which are the two most commonly used visual indexes in fault detection. However, due to the limitation of Cartesian coordinate system, the above methods only show one variable or one detection index in a picture.

Parallel coordinates break the limitation of dimensional representation in Cartesian coordinates and allow to visualize multidimensional data by two-dimensional representation. Each broken line represents several variables for each sampling time, or principal components. The time explicit Kiviat graph is an evolution of parallel coordinates, where polygons are used to represent multivariable or multiple principal components at each sampling time, and the position offset of the polygons indicates the occurrence of faults. However, these methods visualize samples in time series by stacking one atop the other, leading to poorer information representation and possibly obscuring some useful information.

Scatter diagram, which displays two-dimensional data in Cartesian coordinates, has been successfully applied to the visualization of the results such as image recognition and fault diagnosis, but has not yet been applied to the visualization of industrial process fault monitoring. Moreover, most data dimension reduction technologies reduce the data to more than three dimensions. If the scatter diagram is directly used for visualization, the information will be lost and the effect will be poor.

By minimizing the relative entropy between the raw data and the features, t-SNE can transform the data into two dimensions, which has been widely used in visualization. The method makes the low-dimensional features corresponding to the tight high-dimensional data get as close as possible, so the class clusters of the raw data can be presented. However, t-SNE is a non-parametric method, which is not suitable for online situations such as fault monitoring.

### SUMMARY OF THE INVENTION

In order to make up for the above-mentioned deficiencies of the prior arts, the present invention provides an online monitoring visualization method for the industrial process of bi-kernel t-distributed stochastic neighbor embedding (bi-kernel t-SNE). The parameterization of the t-SNE method is improved by the direct mapping relation from the approximate input kernel matrix to the feature kernel matrix. PCA is used to transform the mapped feature kernel matrix into two-dimensional features for visualization, so that both normal data and abnormal values can be correctly mapped. Finally, the square Mahalanobis distance is used as the monitoring statistic, and the scatter diagram is used to display the two-dimensional features. The control limit is an ellipse, which realizes a simple and intuitive visualization presentation.

The present invention is to reduce dimension of the high-dimensional data for industrial process by t-SNE method, and the bi-kernel mapping is used to realize online extension of out-of-sample mapping, and the mapped kernal matrix is reduced to two dimension by PCA. Two-dimensional features and oval control limit are drawn directly in two-dimensional rectangular coordinate system, providing simple and intuitive fault monitoring visualization way, and improving monitoring performance; the specific steps are as follows:

### A. Offline Modeling Stage

1) Historical data X(x₁, x₂. . . , xₙ) are obtained and standardized, where n is the number of variables, and the standardized calculation formula is as follows:

$${x}^{′} = \frac{x - mean ( x )}{std ( x )} \qquad ( 1 )$$

where, mean(⋅) is calculation mean value and std(⋅) is calculation standard deviation;

2) Calculate the low-dimensional feature Y_{tSNE} of X′ by standard t-SNE;

3) Calculate the kernel matrices of X and Y_{tSNE} respectively, and the calculation formula is as follows:

$${[ {K}_{x} ]}_{i , j} = {k}_{x , ij} = exp ( - \frac{{‖ {x}_{i} - {x}_{j} ‖}^{2}}{2 {σ}_{x}^{2}} ) \qquad ( 2 )$$

$${[ {K}_{y} ]}_{i , j} = {k}_{y , ij} = exp ( - \frac{{‖ {y}_{i} - {y}_{j} ‖}^{2}}{2 {σ}_{y}^{2}} ) \qquad ( 3 )$$

4) Calculate the mapping parameter matrix W between kernel matrices by least square method;

W=(Kₓ^{T}·Kₓ)⁻¹·Kₓ^{T}·K_{y} (4)

5) The matrix K_{y} is transformed into the final required two-dimensional feature Y by PCA;

Y=K_{y}·P (5)

Where P is load matrix;

6) Design statistics and control limits: the square Mahalanobis distance is introduced as a statistic, and δ,the 95% confidence limit of the square Mahalanobis distance, is calculated as the fault monitoring control limit using the kernel density estimation. The statistical calculation formula is as follows:

Tᵢ²=(yᵢ−y̅)·S⁻¹·(yᵢ−y̅)^{T} (6)

Where, y̅ and S are the mean value and covariance of each feature yᵢ in the eigenmatrix Y respectively;

7) Draw the scatter diagram and the ellipse control limit of two-dimensional features. The formula of the ellipse control limit is as follows:

(y−y̅)·S⁻¹·(y−y̅)^{T}=δ (7)

### B. Online Monitoring Stage

1) Collect the data of all variables at the current time i to obtain x_{new,k}, and standardize them according to the mean value and variance of each variable obtained offline to obtain x′_{new,k′};

2) Calculate the kernel function of x′_{new,k} and all normal training data X to obtain k_{x,i};

3) Bi-kernel mapping: k_{y,i}=W·K_{x,i};

4) Reduce k_{y,i} to two dimension by PCA: yᵢ=k_{y,i}·P;

5) Fault monitoring visualization: the feature yᵢ obtained in the previous step is traced to a point in the scatter diagram, so as to judge whether there is a fault by observing whether the point exceeds the range of the ellipse control limit or not. In addition, the value of statistics can be calculated by equation (6) and compared with the control limit δ to judge whether there is a fault or not from the perspective of quantification.

### Beneficial Effect

Firstly, the standard t-SNE is used to reduce the dimension of training normal data, and then the bi-kernel mapping is used to realize out-of-sample extension of t-SNE. This method reduces the multivariable industrial process data to two dimensions on the premise of preserving the clustering and trend features of the data as much as possible, so that the data visualization can be realized in the two-dimensional scatter diagram. At the same time, the square Mahalanobis distance is used as a statistic, and the corresponding control limit is ellipse, so the drawing is simple and convenient, and the visualization effect is intuitive. The method of the invention is simple to implement, and compared with other visualization methods, it can reduce the occurrence of misreport and underreport, and improve the accuracy of fault monitoring.

### DESCRIPTION OF DRAWINGS

FIG. 1 is the flow chart of fault monitoring visualization of the bi-kernel t-SNE method of the present invention;

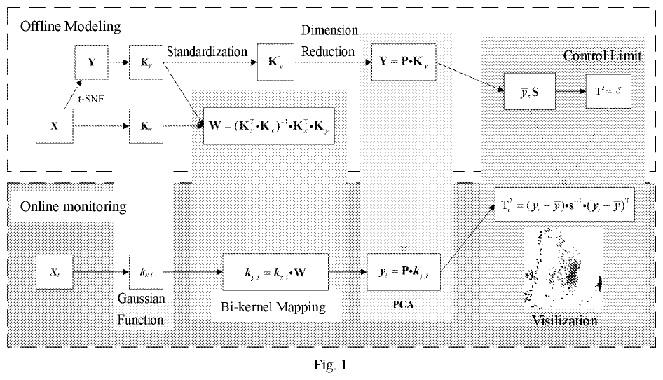

FIG. 2 is the fault monitoring visualization diagram of fault 1 by the bi-Kernel t-SNE method of the present invention, PCA, LPP and NPE method. FIGS. 2(a)-2(d) are the fault monitoring visualization diagrams of bi-kernel t-SNE, PCA, LPP and NPE, respectively.

FIG. 3 is the fault monitoring visualization diagram of fault 4 by the bi-kernel t-SNE method of the present invention, PCA, LPP and NPE method. FIGS. 3(a)-3(d) are the fault monitoring visualization diagrams of fault 4 by the bi-kernel t-SNE, PCA, LPP and NPE, respectively;

FIG. 4 is the fault monitoring visualization diagram of fault 14 by the bi-kernel t-SNE method of the present invention, PCA, LPP and NPE method. FIGS. 4(a)-4(d) are the fault monitoring visualization diagrams of fault 14 by bi-kernel t-SNE, PCA, LPP and NPE, respectively.

### EXEMPLARY EMBODIMENT

Tennessee Eastman Process (TE) is a simulation of actual chemical industry process proposed by J. J. Downs and E. F. Vogel from Tennessee Eastman Chemical Company, USA. It is widely used in the research of process control technology. There are four kinds of main materials involved in the reaction in TE process, namely A, C, D and E, which are all gaseous materials. Two kinds of products G and H, as well as a by-product F, are produced. In addition, a small amount of inert gas B is also included in the product feed. A total of 52 variables were collected during the process with a sampling interval of 3 minutes. It lasts for 25 hours to train normal data set and it lasts for 48 hours to test data set. The fault data tested are normal in the first 8 hours, and the fault is introduced in the 9th hour.

The training data and test data include 1 set of normal data and 21 sets of fault data. The specific fault locations and related descriptions are shown in Table 1.

TABLE 1
21 faults in the TE process

| Faults | Description | Type |
|---|---|---|
| IDV(1) | Feed flow ratio of A/C changes, content of B | Phase Step |
| | does not change | |
| IDV(2) | Content of B changes, feed flow ratio of A/C | Phase Step |
| | does not change | |
| IDV(3) | Temperature of material D changes | Phase Step |
| IDV(4) | Temperature of reactor cooling water inlet | Phase Step |
| | changes | |
| IDV(5) | Temperature of condenser cooling water inlet | Phase Step |
| | changes | |
| IDV(6) | Material A losses | Phase Step |
| IDV(7) | Pressure head of material C losses | Phase Step |
| IDV(8) | Composition of material A, B and C changes | Random |
| IDV(9) | Temperature of material D changes | Random |
| IDV(10) | Temperature of material C changes | Random |
| IDV(11) | Temperature of reactor cooling water inlet | Random |
| | changes | |
| IDV(12) | Temperature of condenser cooling water inlet | Random |
| | changes | |
| IDV(13) | Dynamics constants of reactor Change | Slow drift |
| IDV(14) | Reactor cooling water valve | Valve sticks |
| IDV(15) | Condenser cooling water valve | Valve sticks |
| IDV(16) | Unknown | Unknown |
| | | perturbance |
| IDV(17) | Unknown | Unknown |
| | | perturbance |
| IDV(18) | Unknown | Unknown |
| | | perturbance |
| IDV(19) | Unknown | Unknown |
| | | perturbance |
| IDV(20) | Unknown | Unknown |
| | | perturbance |
| IDV(21) | Valve for flow 4 is fixed in steady state | Constant |
| | position | position |

Based on the above contents, the technical scheme described in the invention is applied to the TE process simulation data mentioned above, and the specific implementation steps are as follows:

### A. Offline Modeling Stage

1) Obtain normal historical data X as training data, and standardize each variable to obtain X′;

2) Calculate the low-dimensional feature Y_{tSNE} of X′ by standard t-SNE;

3) Calculate the kernel matrices Kₓ and K_{y} of X′ and Y_{tSNE} respectively according to equations (2) and (3). In this experiment, the kernel parameter preferences are σₓ=2, σ_{y}=6;

4) Calculate the mapping parameter matrix W between kernel matrices by equation (4);

5) The matrix K_{y} is transformed into the final required two-dimensional feature Y by PCA;

6) Calculate the square Mahalanobis distance as a statistic, and δ, the 95% confidence limit of the square Mahalanobis distance, is calculated as the fault monitoring control limit using the kernel density estimation;

7) Draw the scatter diagram and the ellipse control limit of two-dimensional features.

### B. Online Monitoring Stage

1) Collect the data of all variables at the current time i to obtain x_{new,i}, and standardize it according to the mean value and variance of each variable obtained offline to obtain x′_{new,k;}

2) Calculate the kernel function of x′_{new,k} and all normal training data X to obtain k_{x,i};

3) The kernel function value k_{y,i}=W·K_{x,I} of the feature obtained by bi-kernel mapping;

4) Reduce k_{y,i} to two dimension by PCA: yᵢ=k_{y,i}·P;

5) The feature y, is traced to a point in the scatter diagram to realize fault monitoring visualization, so as to observe whether the point exceeds the range of the ellipse control limit to judge whether there is a fault or not. In addition, the value of statistics can be calculated by equation (5) and compared with the control limit δ to judge whether there is a fault or not from the perspective of quantification.

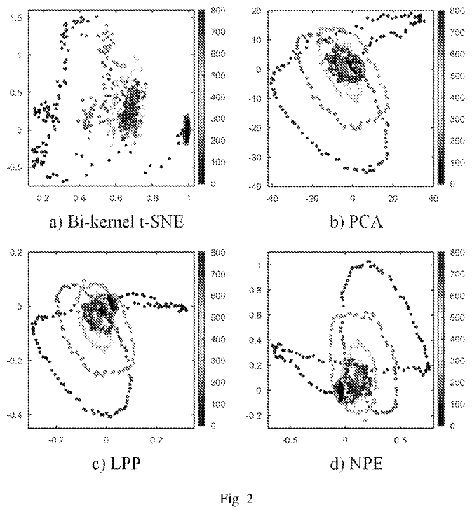

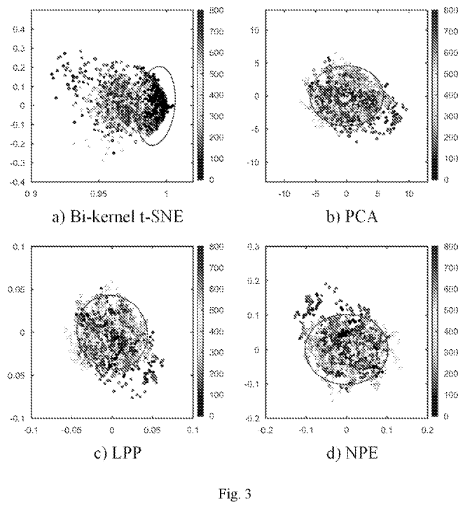

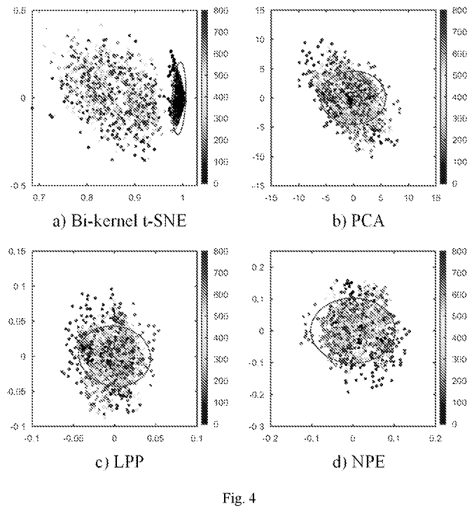

To verify the accuracy and effectiveness of fault monitoring in the proposed method, faults 1, 4 and 14 in TE process were tested respectively, and compared with PCA, LPP and NPE methods. The two-dimensional features are all retained in three comparison methods, and the square Mahalanobis distances used as a statistic to draw a scatter diagram for visualization. The visualization results for faults 1, 4, and 14 are shown in FIGS. 2, 3, and 4.

The black hollow triangle represents the normal training features, the black solid circle represents the normal test data, the gray solid circle represents the test fault data, and the elliptical dotted line represents the control limit. Each test fault contains 800 fault samples, and different gray gradients indicate the sequence of fault samples, so that the visualization diagram can show the distribution of fault features over time variation.

Fault 1 is the phase step change of feed flow ratio of A/C. At the beginning of the change, each variable fluctuates obviously, and after a period of time, the process control system stabilizes the process to a new state. It is obvious in the results of bi-kernel t-SNE method that the fault features deviate greatly in the initial stage and gradually stabilize in another region in the later stage. Although the features of PCA, LPP and NPE deviate at the initial stage of the fault, the features at the later stage basically coincide with the normal feature range, which do not reflect the difference from the normal state. For faults 4 and 14, most of the fault features extracted by PCA, LPP and NPE methods cover the normal range, and only a small part of the fault samples could be detected, while bi-kernel t-SNE could detect almost all the fault samples.

Bi-kernel t-SNE method has high fault detection rate, and its visualization effect is obviously superior to PCA, LPP and NPE methods. This is because the features extracted by t-SNE method contains more information than PCA, LPP and NPE methods, and bi-kernel mapping extends this advantage to the applications in online contexts.

We claim:

1. An monitoring visualization method for the process of bi-kernel t-distributed stochastic neighbor embedding, which is characterized in that: t-SNE method is used to reduce dimension of high-dimensional data for industrial process and bi-kernel mapping is used to realize online extension of out-of-sample mapping, and a mapped kernel matrix is reduced to two dimension by principal component analysis (PCA); two-dimensional features and oval control limit are drawn directly in a two-dimensional rectangular coordinate system, providing simple and intuitive fault monitoring visualization way, and improving monitoring performance; the specific steps are as follows:
A. offline modeling stage:
historical data X(x₁, x₂. . . , xₙ) are obtained and standardized, where n is the number of variables, and the standardized calculation formula is as follows:
$${x}^{′} = \frac{x - mean ( x )}{std ( x )} \qquad ( 1 )$$
where, mean(⋅) is calculation mean value and std(⋅) is calculation standard deviation;
2) calculate a low-dimensional feature Y_{tSNE} of X′ by standard t-SNE;
3) calculate a kernel matrices of X and Y _{tSNE} respectively, and the calculation formula is as follows:
$${[ {K}_{x} ]}_{i , j} = {k}_{x , ij} = exp ( - \frac{{‖ {x}_{i} - {x}_{j} ‖}^{2}}{2 {σ}_{x}^{2}} ) \qquad ( 2 )$$
$${[ {K}_{y} ]}_{i , j} = {k}_{y , ij} = exp ( - \frac{{‖ {y}_{i} - {y}_{j} ‖}^{2}}{2 {σ}_{y}^{2}} ) \qquad ( 3 )$$
4) calculate a mapping parameter matrix W between the kernel matrices by least square method;
W=(Kₓ^{T}·Kₓ)⁻¹·Kₓ^{T}·K_{y} (4)
5) the matrix K_{y} is transformed into the final required two-dimensional feature Y by PCA;
Y=K_{y·P} (5)
where P is load matrix;
6) design statistics and control limits: the square Mahalanobis distance is introduced as a statistic, and δ, the 95% confidence limit of the square Mahalanobis distance, is calculated as the fault monitoring control limit using the kernel density estimation; the statistical calculation formula is as follows:
Tᵢ²=(yᵢ−y̅)·S⁻¹·(yᵢ−y̅)^{T} (6)
where, y̅ and S are the mean value and covariance of the feature yᵢ;
7) draw a scatter diagram and an ellipse control limit of two-dimensional features; the formula of the ellipse control limit is as follows:
(y−y̅)·S⁻¹·(y−y̅)^{T}=δ (7)
B. online monitoring stage:
1) collect data of all variables at current time i to obtain x_{new,k}, and standardize them according to a mean value and variance of each variable obtained offline to obtain x′_{new,k};
2) calculate kernel function of x′_{new,k} and all normal training data X to obtain k_{x,i};
3) bi-kernel mapping: k_{y,i}=W·k_{x,i};
4) reduce k_{y,i} to two dimension by PCA: yᵢ=k_{y,i}·P;
5) fault monitoring visualization: the feature y, obtained in the previous step is traced to a point in the scatter diagram, so as to judge whether there is a fault by observing whether the point exceeds the range of the ellipse control limit or not; in addition, the value of statistics can be calculated by equation (6) and compared with the control limit δ to judge to whether there is a fault or not from the perspective of quantification.
